(19) United States
(12) Patent Application Publication
(10) Pub. No.: US 2012/0230788 A1
(43) Pub. Date: Sep. 13, 2012

(54) SAW TOOL FOR A MACHINE TOOL

(75) Inventors: Milan Bozic, Solothurn (CH); Daniel Grolimund, Zuchwil (CH)

(73) Assignee: Robert Bosch GmbH, Stuttgart (DE)

(21) Appl. No.: 13/510,728

(22) PCT Filed: Sep. 21, 2010
(86) PCT No.: PCT/EP2010/063902

§ 371 Date: May 18, 2012

(30) Foreign Application Priority Data
Nov. 20, 2009 (DE) 10 2009 046 907.9

(51) Int. Cl. B23B 51/04; B23D 61/12

(52) U.S. Cl. 408/209; 83/848; 83/849; 83/846

(57) ABSTRACT

A saw tool for a machine tool that includes at least two saw tooth sequences. Each of the saw tooth sequences has a plurality of saw teeth, wherein a toothless chip space is arranged between successive saw tooth sequences. The first saw tooth directly adjacent to a chip space has a tooth geometry differing from that of the other saw teeth within a saw tooth sequence.

The invention relates to a saw tool for a machine tool, in particular for a portable power tool, according to the preamble of claim 1.

### PRIOR ART

EP 1 228 829 A1 describes a hole saw having a cylindrical drill body and a centre drill which is guided in the drill body and by way of which a drilling core can be sawn out of a workpiece to be machined. On its end side, the cylindrical drill body has cutting teeth, some of which are provided with a set and some without. In the circumferential direction of the drill body, in each case three cutting teeth or sawteeth, which follow one another immediately, without a set and two adjoining cutting teeth having a set angle in the opposite direction form a contiguous sawtooth sequence. A plurality of such sawtooth sequences, which are each formed in the same way, are arranged around the circumference of the end side.

On account of the set sawteeth, there is in each case a small clearance between the inner and outer lateral surfaces of the cylindrical drill body and the sawn out drilling core, on the one hand, and the inner surface of the drilling hole, on the other, said clearance making it easier to remove the drill body from the hole and to remove the drilling core from the inside of the drill body.

### DISCLOSURE OF THE INVENTION

The invention is based on the object of designing a saw tool for a machine tool by way of simple measures such that a clean saw edge is provided at the workpiece to be machined and also catching of the saw tool in the workpiece during machining is counteracted.

This object is achieved according to the invention by way of the features of claim 1. The dependent claims specify expedient developments.

The saw tool according to the invention is used in machine tools, in particular in hand-held machine tools, preferably is motorized machine tools, which have for example an electric motor as the drive motor. On a machining side, the saw tool has cutting teeth or sawteeth, wherein different kinds of saw tools are possible, depending on the use purpose. The saw tool is for example a cylindrical drill body which is used in a hole saw. However, a configuration of the saw tool as a saw blade, which is used for example in oscillating cutting or sawing machines and which is for example a jigsaw blade or saber saw blade, is in principle possible.

The saw tool according to the invention has at least two sawtooth sequences, which each have a plurality of sawteeth on the machining side, wherein the sawtooth sequences are constructed in an identical manner to one another. Between two successive sawtooth sequences there is a tooth-free chip space, which serves to receive or discharge chips or chip dust which is produced during the machining of the workpiece. The chip space increases the direct removal of the chips from the cutting region and as a result reduces the clogging of the row of teeth.

Chip removal is also improved in that the first sawtooth in a sawtooth sequence, said first sawtooth directly adjoining a chip space and being located at the front within the sawtooth sequence in the machining direction, has a tooth geometry that differs from the further sawteeth in this sawtooth sequence. The different tooth geometry of the first sawtooth from the further sawteeth per sawtooth sequence can relate on the one hand to the set, but on the other hand also to the tooth shape and also the position of the sawteeth with respect to one another or with respect to the machining side. In this case, it is in particular provided that the first sawtooth is unset, whereas the following sawteeth have a set. The unset first tooth likewise improves the removal of the chips from the cutting region, thereby reducing the risk of the row of teeth clogging. Catching of the saw tool in the workpiece, which usually consists of metal, is counteracted by these measures.

This embodiment with a plurality of tooth cycles or sequences having a chip space in between in conjunction with an unset first sawtooth and following set sawteeth per sawtooth sequence also has the effect of improving the progress of cutting in combined applications which include the machining of different workpiece materials, such as wood, metal or plaster or machining in drywall.

According to an advantageous embodiment, it is provided that the tooth face of the first sawtooth has a negative rake angle at least in portions, in particular in a portion adjacent to the tooth gullet, whereas the tooth face of the first sawtooth in a portion which extends as far as the tooth tip can have a positive rake angle. This embodiment of the first sawtooth per sawtooth sequence has the advantage that, during the machining of sheet metal, the edge of the sheet metal sheet is diverted away from the chip space and thus cannot pass into the chip space or cant therein. As a result, the risk of the edge of the sheet metal catching in the chip space and, associated therewith, the machine tool jamming is reduced. This effect is also supported by the fact that, in contrast to the first sawtooth, the following sawteeth are each configured without a negative rake angle, but rather have a positive rake angle from the tooth tip to the tooth gullet.

It may be advantageous to provide the tooth face of the first sawtooth with two different portions, which are oriented at an angle to one another, in the region of the tooth gullet, said different portions each having a negative rake angle, the magnitude of which differs, however.

Furthermore, according to an advantageous embodiment, it is provided that, within a sawtooth sequence, the first sawtooth differs from the further sawteeth in terms of its position with regard to the machining side or a parallel to the machining side. The first sawtooth is in particular positioned lower than the further, following sawtooth in its sawtooth sequence, as a result of which the risk of catching is likewise reduced.

With regard to the set of the sawteeth within a sawtooth sequence, according to an expedient embodiment it is provided that sawteeth following the first sawtooth each have a set in the opposite direction.

In the embodiment of the saw tool as a cylindrical drill body for a hole saw, it may be expedient to provide on the inner side of the drill body an additional cutting body having a cutting edge, wherein the cutting edge is offset radially inward with respect to the inner side or the inner wall of the drill body. This embodiment has the advantage that the outside diameter of the sawn out drilling core is smaller than the inside diameter of the cylindrical drill body, so that, after the workpiece has been machined, there is an air gap between the lateral surface of the drilling core and the inner side of the drill body and the sawn out drilling core can be removed from the interior of the drill body without a problem.

Further advantages and expedient embodiments can be gathered from the further claims, the description of the figures and the drawings, in which:

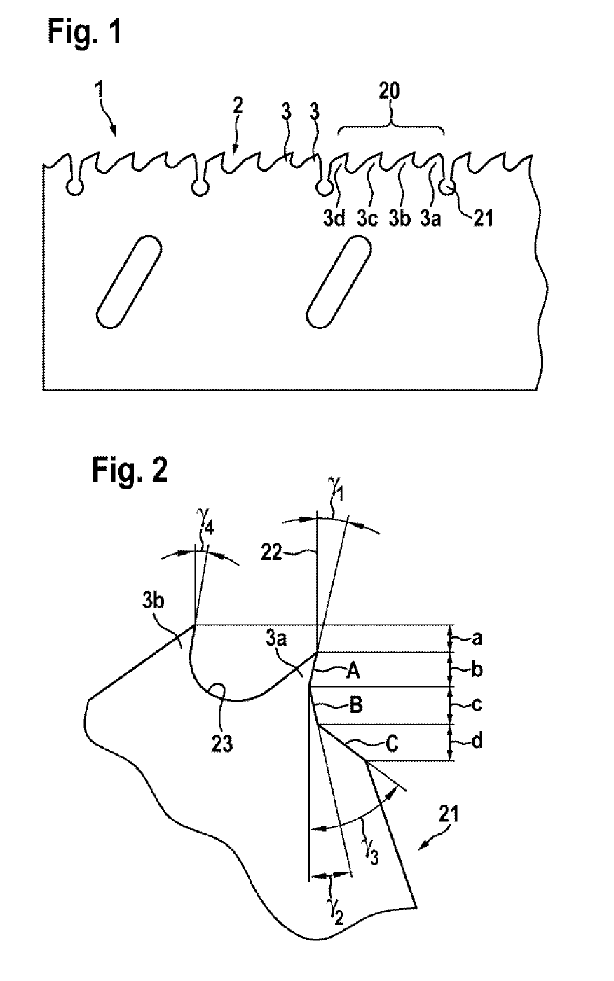

FIG. 1 shows a saw tool for a machine tool, which has a multiplicity of sawteeth on the machining side, said sawteeth being combined to form sawtooth sequences, wherein a chip space is located between adjacent sawtooth sequences,

FIG. 2 shows an enlarged illustration of the sawtooth which is at the front in the machining direction and adjoins the chip space,

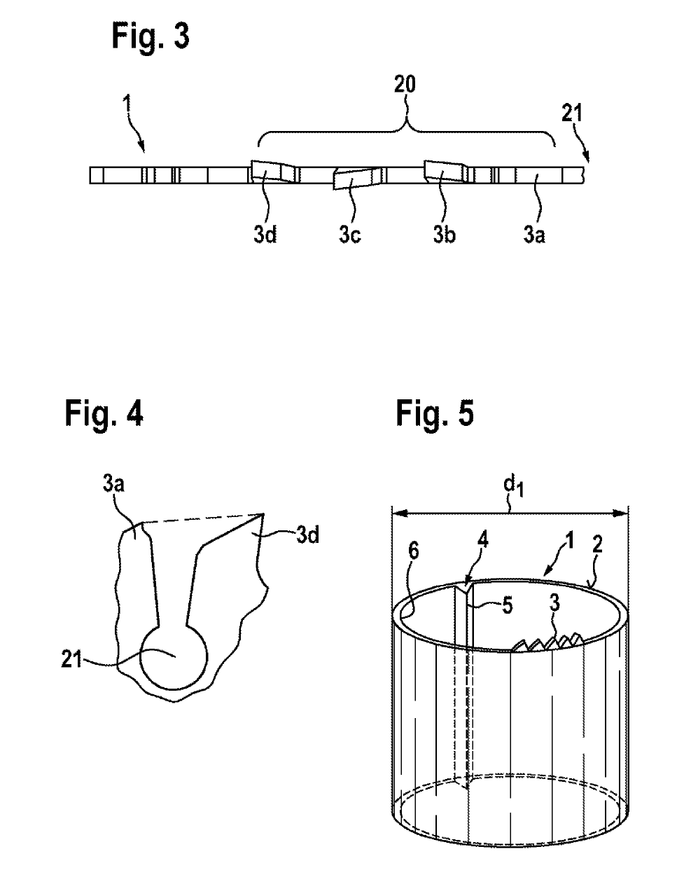

FIG. 3 shows a plan view of a sawtooth sequence,

FIG. 4 shows an enlarged illustration of a chip space,

FIG. 5 shows a perspective view of a cylindrical drill body in a hole saw, said drill body being provided in its free end side with sawteeth for sawing out a drilling core and having on the inner side an axially extending cutting body having a cutting edge that is offset radially inward.

In the figures, identical components are provided with identical reference signs.

FIG. 1 illustrates a saw tool 1, which is embodied for example as a cylindrical drill body for a hole saw or as a saw blade. The saw tool 1 has a machining side 2, on which cutting teeth or sawteeth 3 are arranged. The sawteeth 3 are combined to form sawteeth sequences 20 which are arranged in succession and each comprise a plurality of individual sawteeth 3, wherein, in the exemplary embodiment, there are four sawteeth 3a to 3d per sawtooth sequence 20. Between in each case two successive sawtooth sequences 20 there is a chip space for receiving or discharging sawing chips or chip dust which arise(s) during the machining of the workpiece. The sawteeth 3a to 3d within each sawtooth sequence 20 have a defined tooth geometry, which improves the removal of chips and the cutting pattern. The first sawtooth 3a, which is at the front in the machining direction and is arranged immediately adjacent to a preceding chip space 21, differs from the following sawteeth 3b to 3d in terms of its tooth geometry.

FIG. 2 illustrates an enlarged detail of the first sawtooth 3a immediately following the chip space 21 and also the following, second sawtooth 3b of a common sawtooth sequence. With respect to the machining side or a plane parallel to the machining side, the first sawtooth 3a is positioned lower than the following sawtooth 3b by the amount a, and so the tip of the first sawtooth 3a projects less far toward the outside than the tip of the following sawtooth 3b. Advantageously, the tips of all of the sawteeth following the first sawtooth are at the same height, so that only the first sawtooth is positioned lower.

Furthermore, the tooth face of the first sawtooth 3a is configured in a different manner than the further sawteeth. The face of the first sawtooth 3a has, between the tooth tip and the transition to the chip space 21, three at least approximately straight portions or edges A, B and C, which each have a different rake angle γ₁, γ₂ and γ₃, respectively, with respect to a vertical 22 to the machining side or to the machining direction. The topmost edge A, which extends from the tooth tip in the direction of the tooth gullet or chip space 21, has a positive rake angle γ₁, which is expediently in a range of values up to 20° and is for example 10°. The adjoining further edges B and C have, by contrast, a negative rake angle γ₂ and γ₃, respectively, wherein the rake angle γ₂ of the central edge B is expediently likewise in a range of values up to 20° and is preferably 5°, whereas the rake angle γ₃ of the lowest edge C is greater than γ₂ and is for example 45°.

The tip of the first sawtooth 3a is placed lower than the tip of the following sawtooth 3b and of all the following sawteeth in this tooth sequence by the amount a. The vertical extent of the edges A, B and C is designated b, c and d, respectively; projected onto the vertical 22, the extents b, c and d are at least approximately the same size. The lower positioning of the first sawtooth 3a by the amount a is in an order of magnitude of up to 0.5 mm and is for example 0.3 mm.

The length, projected into the vertical, of the first edge A and also of the second, central edge B, is also in each case in a range of values up to 0.5 mm and is for example 0.3 mm. The length d, projected into the vertical, of the lowest edge C is in a range of values up to 0.8 mm and is for example 0.4 mm.

FIG. 3 illustrates a plan view of the machining side of a saw tool 1 having a sawtooth sequence 20 consisting of four sawteeth 3a to 3d. The first sawtooth 3a is straight, i.e. configured without a set, whereas the further sawteeth 3b, 3c and 3d each have a set, specifically alternating in opposite directions.

In contrast to the first sawtooth 3a, the following sawteeth have exclusively a positive rake angle, but no negative rake angle. This is illustrated by way of example in FIG. 2 on the basis of the second sawtooth 3b, which is provided with the positive rake angle γ₄, which extends from the tooth tip as far as the transition into the tooth gullet 23 along the straight edge of the tooth face. All of the sawteeth following the first sawtooth in a tooth sequence can have the same positive rake angle, wherein, in principle, different, positive rake angles are also possible. The rake angle γ₄ of the following teeth can be either the same size as the positive rake angle γ₁ of the first sawtooth 3a or else differ therefrom, i.e. either be smaller or larger than the positive rake angle of the first sawtooth.

FIG. 4 shows an illustration of just the chip space 21 with the adjoining sawteeth 3a of a following tooth sequence and 3d of a preceding tooth sequence. As indicated by way of a dashed line, the first sawtooth 3a of the following tooth sequence is positioned slightly lower than the last sawtooth 3d of the preceding tooth sequence.

FIG. 5 illustrates a cylindrical or cup-shaped drill body 1 as a saw tool which is used in a hole saw for sawing out a drilling core. At its free end side 2, the drill body 1 has a row of only partially illustrated cutting teeth or sawteeth 3, which are embodied in the above-described manner with sawtooth sequences having a chip space in between. On the inner side 6 of the cylindrical drill body 1 there is a cutting body 4, which extends along the axial length of the drill body and is provided with a cutting edge 5 that is directed radially inward. The cutting body 4 has a triangular cross section, wherein the tip of the triangle, which is directed radially inward, forms the cutting edge 5. The cutting edge 5 extends axially as far as the free end side 2 of the drill body 1, but the cutting body 4 expediently does not project axially as far as the cutting teeth 3. In the circumferential direction, the cutting body 4 extends only over a narrow angular segment of, for example, at most 5°.

1. A saw tool for a machine tool comprising:
at least two sawtooth sequences arranged on a machining side of the saw tool, each of the sawtooth sequences having a plurality of sawteeth,
wherein a tooth-free chip space is arranged between successive sawtooth sequences, and
wherein, within at least one sawtooth sequence, a first sawtooth directly adjoining the chip space has a tooth geometry that differs from further sawteeth.

2. The saw tool as claimed in claim 1, wherein, within the at least one sawtooth sequence, the first sawtooth has a tooth shape that differs from the further sawteeth.

3. The saw tool as claimed in claim 2, wherein the first sawtooth has a tooth face that has a negative rake angle at least in portions.

4. The saw tool as claimed in claim 3, wherein the tooth face has a negative rake angle adjacent to a tooth gullet.

5. The saw tool as claimed in claim 4, wherein, adjacent to the tooth gullet, the tooth face has two portions or edges having negative rake angles of different magnitudes.

6. The saw tool as claimed in claim 4, wherein the tooth face has a positive rake angle adjacent to a tooth tip.

7. The saw tool as claimed in claim 6, wherein the further sawteeth following the first sawtooth within the at least one sawtooth sequence each have a positive rake angle between the tooth tip and the tooth gullet.

8. The saw tool as claimed in claim 1, wherein, within the at least one sawtooth sequence, a position of the first sawtooth from a parallel to the machining side of the saw tool differs from a position of the further sawteeth from the same parallel.

9. The saw tool as claimed in claim 8, wherein the position of the first sawtooth is lower than the position of the further sawteeth.

10. The saw tool as claimed in claim 9, wherein, within the at least one sawtooth sequence, a set of the first sawtooth differs from a set of the further sawteeth.

11. The saw tool as claimed in claim 10, wherein the first sawtooth is formed without a set angle and the further sawteeth are formed with a set angle.

12. The saw tool as claimed in claim 1, wherein the saw tool is configured as a cylindrical drill body for a hole saw.

13. The saw tool as claimed in claim 12, wherein the cylindrical drill body has an end at which the cutting teeth or sawteeth are arranged for sawing out a drill core, the sawteeth are being combined to form sawteeth sequences, and wherein on the inner side of the drill body there is arranged a cutting body having a cutting edge which is offset radially inward with respect to the inner side of the drill body.

14. The saw tool as claimed in claim 1, wherein the saw tool is configured as a saw blade.

15. A machine tool including a saw tool, the saw tool comprising:
at least two sawtooth sequences arranged on a machining side of the saw tool, each of the sawtooth sequences having a plurality of sawteeth,
wherein a tooth-free chip space is arranged between successive sawtooth sequences, and
wherein, within at least one sawtooth sequence, a first sawtooth directly adjoining the chip space has a tooth geometry that differs from further sawteeth.
